(19) United States
(12) Patent Application Publication
(10) Pub. No.: US 2002/0154388 A1
(43) Pub. Date: Oct. 24, 2002

(54) A MULTIMODE OPTICAL AMPLIFYING FIBER WITH A TRANSVERSELY COUPLED OPTICAL PUMPING BEAM

(76) Inventors: Francois Boubal, Paris (FR); Paul Salet, Clamart (FR); Mauro Bettiati, Fontenay Aux Roses (FR); Gerard Gelly, Cheptainville (FR)

Correspondence Address: Sughrue Mion Zinn MacPeak and Seas PLLC, 2100 Pennsylvania Avenue N W, Washington, DC, 20037-3213, US

(21) Appl. No.: 09/504,121

(22) Filed: Feb. 15, 2000

(30) Foreign Application Priority Data
Feb. 15, 1999 (FR) 9901795

(51) Int. Cl. H01S 3/00

(52) U.S. Cl. 359/341.3

(57) ABSTRACT

The invention relates to an optical amplifier (3) in which a source beam (1) and a pumping beam (2) are coupled.

The pumping beam (P) is introduced into the fibre (3) laterally with respect to the optical axis (5) of the fibre, and focused by the curvature of the fibre (3) on a mirror (6) formed by a polished end face (8) so as to deflect it inside a numerical aperture cone of the optical fibre (3).

The present invention relates to the field of optical-fibre amplifiers mainly used in the context of optical information transmission.

Such amplifiers are principally composed of two concentric cores: a monomode central core consisting of an amplifying material and intended for propagating the signal, and a multimode core, surrounding the monomode core, used for the propagation of a pumping beam.

The light signal propagating in the monomode core of the optical fibre can be emitted by a 1.55 μm source, for example, or come from the output facet of an optical fibre. This light signal carries the optical information which it is wished to amplify in the amplifying optical fibre of the present invention.

The pumping beam is emitted by an injection laser able to emit a high-power beam. The pumping beam is propagated in the multimode core of the optical fibre and passes regularly through the monomode core. The interaction between the signal beam and the pumping beam makes it possible to amplify the first by transmitting part of the power of the pumping beam to the signal beam.

Double-core optical amplifiers are already well-known in the prior art.

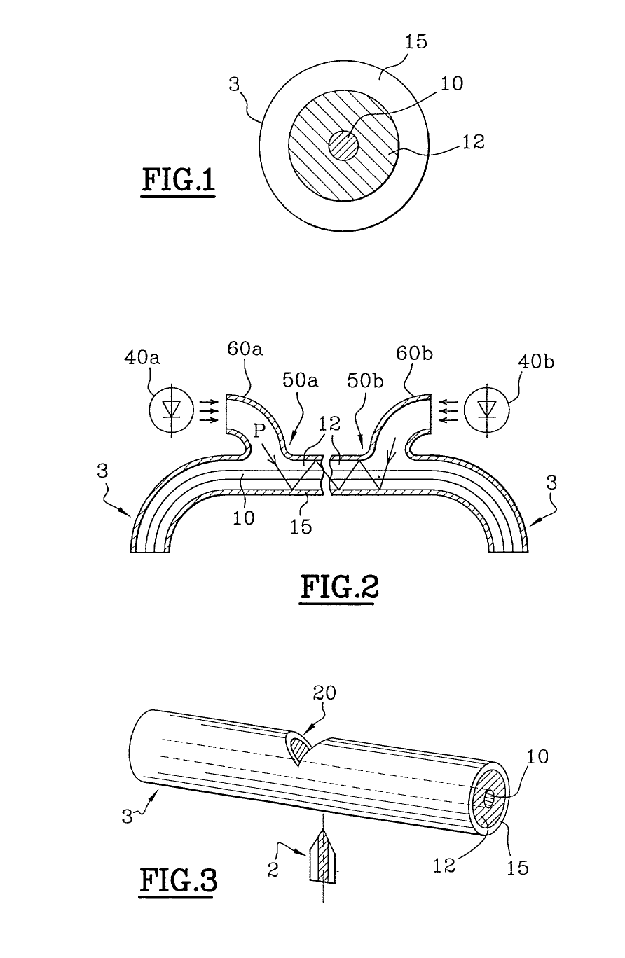

In particular, European patent application EP 0 776 074 describes the structure of a double-core optical amplifier. FIG. 1 is a sectional view of a double-core optical fibre described in this document.

Such an optical fibre consists of a monomode central core 10 having the standard dimensions of optical fibres used in telecommunications. This core 10 is composed of an amplifying material. It can, for example, be doped with ytterbium and/or erbium.

A multimode core 12 surrounds the monomode core 10 and guides a pumping beam inside the optical fibre 3 so as to stimulate the amplification of the signal beam propagating in the monomode core 10. A sheath 15 surrounds the multimode core 12.

The refractive index is highest in the central core and lowest in the sheath. Thus the two concentric cores behave like waveguides.

The main advantage of the double-core structure is that the light can propagate in the outer core until it is absorbed by the doping material of the central core. The signal beam is thus amplified optically by the reversals of populations due to the absorptions of the pumping beam by the material of the central core.

Such a structure provides an in-line optical fibre amplifier with high gain.

In certain applications, such a structure can also constitute a fibre laser if the fibre is closed by a Bragg grating.

The main problem encountered in the use of such optical fibres consists in the coupling of the two optical beams, that is to say the coupling of the pumping beam in the multimode core at the same time as the insertion of the signal beam in the monomode core.

Different solutions have already been developed in the state of the art in order to remedy this coupling problem.

A first solution consists in using an optical fibre with a multimode core with a sufficiently large diameter to make it possible to more easily inject the pumping beam into the fibre. This solution is not satisfactory since it gives rise to an increase in the size of the multimode part of the optical fibre and consequently a reduction in the number of interactions between the pumping beam and the signal beam.

Such a solution does not therefore have optimum efficiency.

A second solution consists in transversely coupling the pumping beam in the multimode core of the optical fibre. This solution, illustrated in FIG. 2, is described in the patent application WO 95/10868.

A pumping beam coming from a laser diode 40a is coupled transversely in the multimode core 12 of an optical fibre 3 through a multimode optical fibre 60a and a multimode coupler 50a, the latter being preferentially asymmetric. The pumping beam P propagates in the multimode core 12, by multiple reflections on the sheath 15 surrounding the multimode core 12.

These multiple reflections enable the pumping beam P to pass several times through the monomode core 10 in which the signal beam propagates so as to stimulate its amplification.

According to a particular embodiment, a supplementary laser diode 40b can inject another beam through another multimode fibre 60b and another coupler 50b so as to increase the pumping power in order to obtain a more uniform power distribution along the optical fibre.

The solution proposed by patent WO 95/10868 has the advantage of simultaneously coupling the pumping beam with the source beam.

Nevertheless, the use of multimode fibres 60a, 60b and multimode couplers 50a, 50b gives rise to high losses. This is because the losses appear at the coupling between the laser diodes 40a, 40b and the input of the multimode fibres 60a, 60b and also at the couplers 50a, 50b.

In addition, this solution of coupling the pumping beam with the signal beam in a double-core fibre is not very compact.

A third solution consists in creating notches in the optical fibre in order to produce mirrors able to deflect the pumping beam inside the multimode core of the optical fibre.

Such a solution, illustrated in FIG. 3, is described in the patent application WO 97/21124, which relates to a method of lateral coupling of a pumping beam in a fibre.

Notches 20 are formed directly in the wall of the multimode core 12 of the optical fibres 3 using mechanical polishing techniques. Preferentially, these notches have a 90° apex and an angle of 45° with respect to the wall of the multimode core 12.

The pumping beam P is then deflected over these notches 20 so as to propagate inside the multimode core 12.

In the context of a standard optical fibre with a multimode core with a diameter of 125 μm and a central core with a diameter of 10 μm, the depth of the notches 20 must not exceed 52.5 μm.

The deflection of the pumping beam P, which typically has a horizontal dimension of 112 μm, will give rise to a loss of half the light power in the horizontal direction. A lens system can be used upstream in order to focus the beam in the horizontal direction before it is deflected in the notch, but this solution makes the coupling system proposed more unwieldy.

In addition, producing notches inside the optical fibre is not obvious.

The aim of the present invention is to remedy the drawbacks of the prior art. The present invention proposes another solution for simultaneously coupling a pumping beam with a source beam in a double-core optical fibre.

The aim of the present invention is to effect such a coupling in a simple and effective manner. To this end, the present invention proposes to use the double-core optical fibre as a lens in order to focus the pumping beam inside the multimode core on one of the end faces of the optical fibre polished so as to constitute a mirror able to deflect the pumping beam inside the multimode core.

The object of the present invention is more particularly an optical amplifier comprising an amplifying fibre associated with a laser source emitting an optical pumping beam towards the fibre, characterised in that the pumping beam is introduced into the fibre laterally with respect to the optical axis of the fibre, and in that the fibre comprises a mirror formed by a polished end face so as to deflect the pumping beam inside a numerical aperture cone of the optical fibre.

According to another characteristic, the pumping beam is focused onto the mirror by a lens formed by the curvature of the optical fibre.

According to one characteristic, the pumping beam with an elliptical cross-section issuing from the laser is transformed by the curvature of the optical fibre into a beam internal to the said fibre having a substantially circular cross-section.

According to another characteristic, the polishing angle θ of the mirror of the end face of the fibre is greater than the total angle of reflection.

According to another characteristic, the angle of incidence β of the pumping beam with respect to the optical axis of the fibre is determined from the polishing angle θ of the mirror of the end face of the fibre.

According to another characteristic, the angle of incidence α of the source beam with respect to the optical axis of the fibre is determined from the polishing angle θ of the mirror of the end face of the fibre.

According to another characteristic, the pumping beam is introduced into the optical fibre with an angle of incidence β of 90° and the end face of the fibre is polished as a mirror with a polishing angle θ of 45°.

According to a variant, the end face is partially polished in order to constitute a mirror, the other portion of the end face of the fibre being perpendicular to the optical axis so as to introduce the source beam in line with the optical axis.

The optical amplifier according to the invention has the advantage of effectively coupling the pumping beam in the optical fibre simultaneously with the source beam.

The invention also has the advantage of using the optical fibre directly for producing the coupling, which affords an easy and inexpensive solution to the coupling of a pumping beam in a double-core fibre.

In addition, the coupling of the pumping beam in the amplifying fibre minimises the light energy losses since the entire width of the input face of the fibre can be used for the deflection of the pumping beam. Thus, in the case of a standard fibre with a diameter of 125 μm and a pumping beam with a divergence of 112 μm, the entire pumping beam will be deflected in the multimode core, and the efficacy of the amplification will be increased.

In addition, the pumping beam is an elliptical beam which has a high vertical divergence, around 40 to 50°, and a low horizontal divergence, around 5 to 10°. The refraction of the pumping beam on the curved part of the fibre compensates for the vertical divergence. Thus the light energy losses will be limited by the focusing of the beam through the curvature of the fibre.

In particular, the laser source emitting the pumping beam can advantageously be positioned so that the pumping beam issuing from the laser is transformed by the curvature of the optical fibre into a beam internal to the said fibre having a substantially circular cross-section.

It is therefore possible to optimise the position and relative distance of the pump laser with respect to the fibre in order to obtain a deflected pumping beam with a substantially circular cross-section. This is because the lens formed by the optical fibre is cylindrical and the major axis of the pumping beam can be introduced perpendicularly to the axis of the fibre.

A simulation can be carried out by optimising the distance and positioning parameters in order to obtain a coupling of 93% for a multimode core fibre of 50 μm.

The optical amplifier according to the invention also has the advantage of having an entry face cleft on a slant, which makes it possible to prevent light reflections on this entry face and thus to avoid a laser effect in the amplifier fibre.

In addition, polishing an end face of an optical fibre is easy to achieve in an industrial context.

Other particularities and advantages of the present invention will emerge during the following description, given by way of illustrative and non-limitative example made with reference to the accompanying figures, in which:

FIG. 1, already described, is a sectional view of a double-core optical fibre known from the state of the art,

FIG. 2, already described, is a side view of the coupling of a pumping beam in a double-core optical fibre according to a first method of the state of the art,

FIG. 3, already described, is a side view of the coupling of a pumping beam in a double-core optical fibre according to a second method of the state of the art,

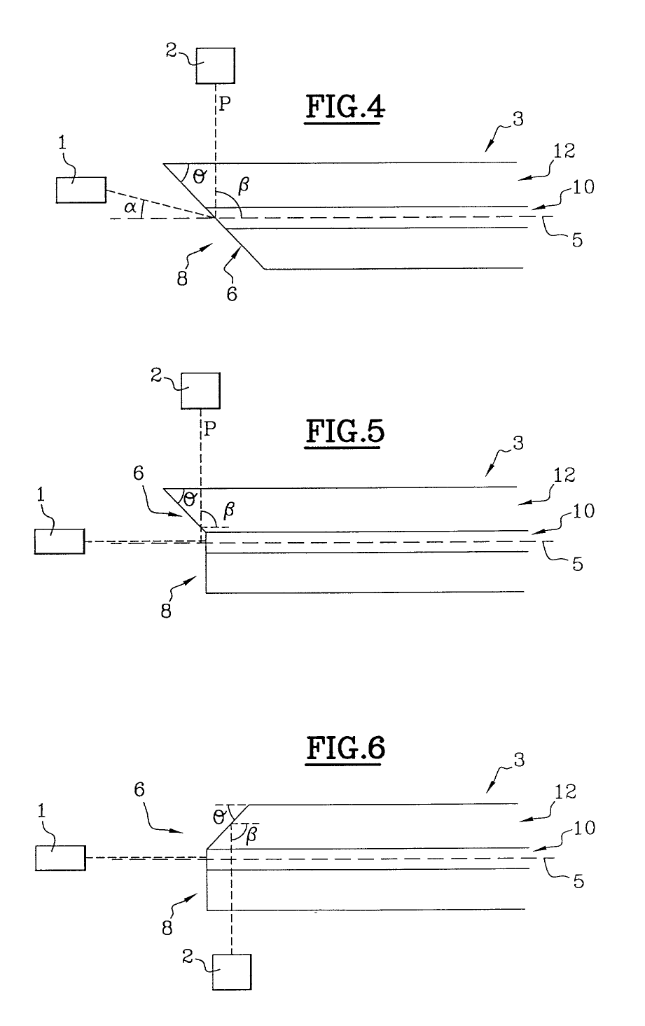

FIG. 4 is a side view of the coupling of a pumping beam in a double-core optical fibre according to a first embodiment of the present invention,

FIG. 5 is a side view of the coupling of a pumping beam in a double-core optical fibre according to a second embodiment of the present invention,

FIG. 6 is a side view of the coupling of a pumping beam in a double-core optical fibre according to a third embodiment of the present invention,

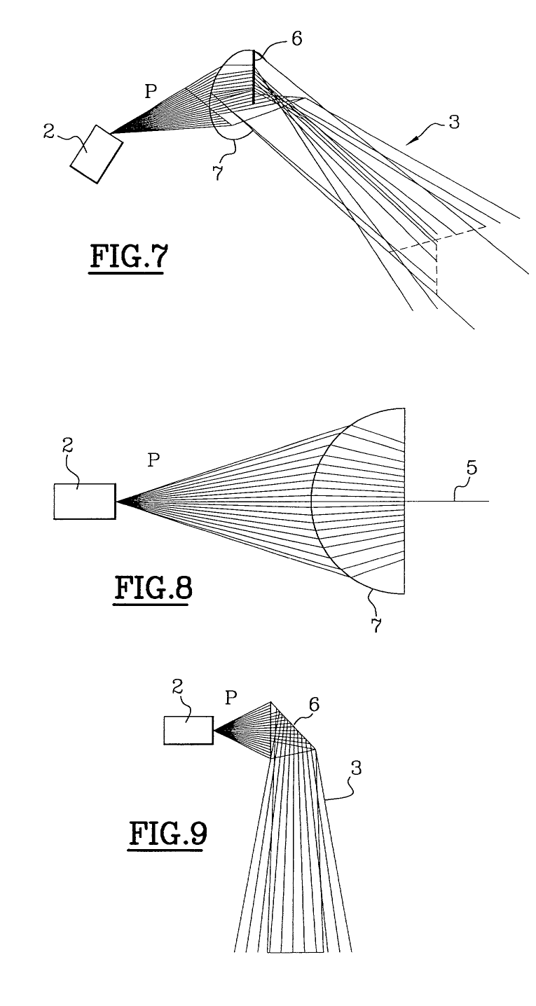

FIG. 7 is a three-dimensional view of the deflection of the pumping beam,

FIG. 8 is a view in the perpendicular plane in the deflection of the pumping beam,

FIG. 9 is a view in the transverse plane in the deflection of the pumping beam.

FIG. 4 illustrates a first embodiment of the coupling of a pumping beam in a double-core optical fibre according to the present invention.

The optical fibre 3 comprises a monomode central core 10 in which there is propagated a signal beam emitted by a source laser 1, for example a 1.55 μm laser.

Whilst remaining within the scope of the present invention, the signal beam can come from another optical fibre or pass through lenses before entering the optical fibre 3 of the optical amplifier.

The source beam enters the optical fibre 3 with an angle of incidence α. In fact, the end face 8 of the optical fibre 3 being polished as a reflective mirror 6, the source beam must have a non-zero angle of incidence so as to propagate in the monomode core 10.

The optical fibre 3 also comprises a multimode core 12 surrounding the monomode core 10. The difference in index between the two concentric cores is sufficiently high to guarantee a relatively large numerical aperture of the multimode core.

The object of the invention is to succeed in coupling a pumping beam P coming from an injection laser 2 in the multimode core 12. This objective is achieved by producing a mirror 6 from the entry face 8 of the optical fibre 3.

The pumping beam P is deflected in the optical fibre 3 by the mirror 6 formed by the polished end face 8 of the optical fibre 3.

The optical fibre 3 is a cylinder and has a radius of curvature 7 which can advantageously form a lens focusing the pumping beam P on the mirror 6. The relative positioning of the laser 2 emitting the pumping beam P with respect to the optical fibre is optimised so as to allow the transformation of the elliptical pumping beam P into a beam with a substantially circular cross-section inside the optical fibre 3.

The mirror 6 has a polishing angle θ with respect to the optical axis 5 of the fibre 3. This angle θ determines the position of the injection laser 2 according to the refractive index n of the optical fibre.

The polishing angle θ of the mirror 6 makes it possible to determine the angle of incidence β of the pumping beam P.

The theoretical formulae are as follows:

β+2θ=π (1)

sin (π/2+α−θ)=n(fibre)* sin (π/2−θ) (2)

However, it is nevertheless required that the polishing angle θ should be greater than the total angle of reflection which corresponds to the angle at which the pumping beam is entirely reflected in the optical fibre.

In order to obtain total reflection of the pump beam in the fibre, it is necessary that:

n(fibre)* sin (β/2)>1

that is to say:

n(fibre)* sin (π/2−θ)>1

However, with this constraint, equation (2) no longer has a solution. It is therefore necessary for one of the couplings to be slightly shifted within the limits of the numerical aperture of the fibre.

This then gives:

β=π−2θ=δβ

with δβ<numerical aperture of the fibre.

FIGS. 4 and 5 are drawn with an angle of incidence β of the pumping beam of 90° and a polishing angle θ of 45°, for a reflection between the air and the glass of the optical fibre.

FIGS. 5 and 6 illustrate second and third embodiments of the coupling of a pumping beam in a double-core optical fibre according to the present invention.

According to these embodiments, the entry face 8 of the fibre 3 is partially polished as a mirror 6 so as to allow the reflection of the pumping beam P in the multimode core 12 whilst making it possible to align the source signal 1 with the optical axis 5 of the optical fibre 3. The angle of incidence α of the source beam will then be zero.

A fourth embodiment, not illustrated, consists in effecting the partial cleaving illustrated in FIG. 5 with rotational symmetry. A straight cleaving at the centre of the entry face of the fibre makes it possible to introduce the signal beam into the central monomode core in the optical axis of the fibre. The polished mirror over the circumference of the fibre in rotational symmetry makes it possible to introduce several pumping beams into the multimode core at several points on the entry face of the fibre.

FIGS. 7 to 9 illustrate simulations of the deflection of the pumping beam P in the multimode core of the optical fibre 3.

These simulations were carried out for a standard optical fibre having a radius of curvature of 62.5 μm, for which the end face 8 has been polished at 45° as a mirror 6.

It can be seen clearly that the curvature 7 of the optical fibre 3 serves as a lens for the pumping beam P and the end face 8 of the optical fibre serves as a mirror 6 for reflecting the pumping beam inside a numerical aperture cone of the multimode core 12.

1. An optical amplifier comprising an amplifying fibre (3) associated with a laser source (2) emitting an optical pumping beam towards the fibre, characterised in that the pumping beam (P) is introduced into the fibre (3) laterally with respect to the optical axis (5) of the fibre, and in that the fibre (3) comprises a mirror (6) formed by an end face (8) polished so as to deflect the pumping beam (P) inside a numerical aperture cone of the optical fibre (3).

2. An optical amplifier according to claim 1, characterised in that the pumping beam (P) is focused on the mirror (6) by a lens (7) formed by the curvature of the optical fibre (3).

3. An optical amplifier according to either one of the preceding claims, characterised in that the pumping beam (P) with an elliptical cross-section issuing from the laser (2) is transformed by the curvature of the optical fibre (3) into a beam internal to the said fibre (3) having a substantially circular cross-section.

4. An optical amplifier according to one of the preceding claims, characterised in that the polishing angle θ of the mirror (6) of the end face (8) of the fibre (3) is greater than the total angle of reflection.

5. An optical amplifier according to claim 4, characterised in that the angle of incidence β of the pumping beam (P) with respect to the optical axis (5) of the fibre (3) is determined from the polishing angle θ of the mirror (6) of the end face (8) of the fibre (3).

6. An optical amplifier according to claim 4, characterised in that the angle of incidence α of the source beam (1) with respect to the optical axis (5) of the fibre (3) is determined from the polishing angle θ of the mirror (6) of the end face (8) of the fibre (3).

7. An optical amplifier according to any one of the preceding claims, characterised in that the pumping beam (P) is introduced into the optical fibre (3) with an angle of incidence β of 90°, the end face (8) of the fibre (3) being polished as a mirror (6) with a polishing angle θ of 45°.

8. An optical amplifier according to any one of the preceding claims, characterised in that the end face (8) is partially polished in order to constitute a mirror (6), the other portion of the end face (8) of the fibre (3) being perpendicular to the optical axis (5) so as to introduce the source beam (1) in line with the optical axis (5).
